(19) United States
(12) Patent Application Publication
(10) Pub. No.: US 2024/0054665 A1
(43) Pub. Date: Feb. 15, 2024

(54) IMAGE PROCESSING APPARATUS, METHOD, AND PROGRAM

(71) Applicant: NIPPON TELEGRAPH AND TELEPHONE CORPORATION, Tokyo (JP)

(72) Inventors: Masato ONO, Musashino-shi, Tokyo (JP); Takashi SANO, Musashino-shi, Tokyo (JP); Shinji FUKATSU, Musashino-shi, Tokyo (JP); Yumi KIKUCHI, Musashino-shi, Tokyo (JP)

(73) Assignee: NIPPON TELEGRAPH AND TELEPHONE CORPORATION, Tokyo (JP)

(21) Appl. No.: 18/279,874

(22) PCT Filed: Mar. 23, 2021
(86) PCT No.: PCT/JP2021/011980

§ 371 Date: Sep. 1, 2023

(51) Int. Cl. G06T 7/50; G06T 7/62

(52) U.S. Cl. CPC G06T 7/50; G06T 7/62; G06T 2207/10028

(57) ABSTRACT

An image processing device according to an embodiment includes: a frame determination unit that, when a size of a differential region between one frame and a frame after the frame in chronological order in a moving image satisfies a predetermined condition and is large, determines the one frame and the frame at a later timing as first and second frames serving as generation sources of functions used for mapping depths of the frames; a depth estimation unit that estimates a depth of each frame between the first and second frames; and a function generation unit that generates the function used for mapping the depth of the first frame as a function usable for mapping the depth of the each frame and generates the function used for mapping the depth of the second frame.

### TECHNICAL FIELD

An embodiment of the present invention relates to an image processing device, method, and program.

### BACKGROUND ART

There is a technique of compressing a depth of a still image. For example, Non Patent Literature 1 discloses that a position where a target object exists is set on a display surface on the basis of the fact that a range in which a user effectively feels parallax is a periphery of the display surface and that a depth is non-linearly mapped onto an input image by setting a 5th percentile of the depth as a minimum value of the depth and setting a 95th percentile of the depth as a maximum value of the depth.

A function used when the depth is mapped as described above will be referred to as a depth compression function. In a case where depth compression processing is performed on each different image, the depth compression function is different depending on a distribution of the depth in the image.

Non Patent Literature 2 discloses that a parallax layer is derived from a histogram analysis result of parallax, and a depth within a certain range of a layer in which a target object exists is extended. Therefore, it is possible to sufficiently express a depth of a detailed part of the target object.

### CITATION LIST

### Non Patent Literature

Non Patent Literature 1: Gaze Stereo 3D: Seamless Disparity Manipulations (Petr Kelnhofer, et al., “azeStereo3D: Seamless Disparity Manipulations”, ACM Transactions on Graphics—Proceedings of ACM SIGGRAPH 2016, Volume 35, Issue 4, 2016.

Non Patent Literature 2: Sangwoo Lee, Younghui Kim, Jungjin Lee, Kyehyun Kim, Kyunghan Lee and Junyong Noh, “Depth manipulation using disparity histogram analysis for stereoscopic 3D”, The Visual Computer 30(4):455-465, April 2014.

### SUMMARY OF INVENTION

### Technical Problem

In a case where the above technique of compressing the depth is applied to a moving image (video) as it is, a display surface needs to be set in each frame of the moving image. Therefore, it is necessary to perform the depth compression processing on all frames of the moving image.

In each frame of the video, the frames have short intervals, for example, the frames have intervals of 16.6 msec in a case where a frame rate is 60 fps, and thus a motion of a subject is generally limited. Therefore, a large difference is not generated between the frames.

However, in a case where a depth estimation result has low accuracy, that is, in a case where depth information varies in each frame, the user may feel uncomfortable, for example, may feel that the depth seems to change even though the subject only slightly moves while the user is viewing a three-dimensional (3D) video.

The depth compression processing is processing of extending a depth of an uncompressed image and therefore also extends the variation of the depth information. Thus, the user may feel more uncomfortable.

In a case where the conventional depth compression processing is performed, the processing includes processing of solving an optimization problem. Therefore, as the processing time increases, the depth compression function further varies and may result in an abnormal solution.

The present invention has been made in view of the above circumstances, and an object thereof is to provide an image processing device, method, and program capable of appropriately compressing a depth of an image.

### Solution to Problem

An image processing device according to an aspect of the present invention includes: a difference calculation unit configured to calculate a size of a differential region between one frame and a frame at a timing later than a timing of the one frame in chronological order in a moving image; a frame determination unit configured to, when the size of the differential region calculated by the difference calculation unit satisfies a predetermined condition and is large, determine the one frame as a first frame serving as a generation source of a function used for mapping a depth of the one frame and determine the frame at the later timing as a second frame serving as a generation source of a function used for mapping a depth of the frame; a depth estimation unit configured to estimate a depth of each frame from the first frame to the second frame; and a function generation unit configured to generate the function used for mapping the depth of the first frame determined as the generation source frame by the frame determination unit as a function usable for mapping the depth of the each frame between the first frame and the second frame and generate the function used for mapping the depth of the second frame determined as the generation source frame by the frame determination unit.

An image processing method according to an aspect of the present invention is an image processing method performed by an image processing device, the image processing method including: calculating a size of a differential region between one frame and a frame at a timing later than a timing of the one frame in chronological order in a moving image; when the calculated size of the differential region satisfies a predetermined condition and is large, determining the one frame as a first frame serving as a generation source of a function used for mapping a depth of the one frame and determining the frame at the later timing as a second frame serving as a generation source of a function used for mapping a depth of the frame; estimating a depth of each frame from the first frame to the second frame; and generating the function used for mapping the depth of the first frame as a function usable for mapping the depth of the each frame between the first frame and the second frame and generating the function used for mapping the depth of the second frame.

### Advantageous Effects of Invention

According to the present invention, it is possible to appropriately compress a depth of an image.

### BRIEF DESCRIPTION OF DRAWINGS

FIG. 1 is a block diagram illustrating an application example of a depth map generation device according to an embodiment of the present invention.

FIG. 2 illustrates an example of a relationship among chronologically continuous frames, keyframes, and depth compression functions.

FIG. 3 is a flowchart showing an example of a processing operation by a depth map generation device according to an embodiment of the present invention.

FIG. 4 illustrates a specific example of a processing operation by a depth map generation device according to an embodiment of the present invention.

FIG. 5 illustrates an example of calculation of a difference between frames.

FIG. 6 is a block diagram illustrating an example of a hardware configuration of a depth map generation device according to an embodiment of the present invention.

### DESCRIPTION OF EMBODIMENTS

Hereinafter, an embodiment according to the present invention will be described with reference to the drawings.

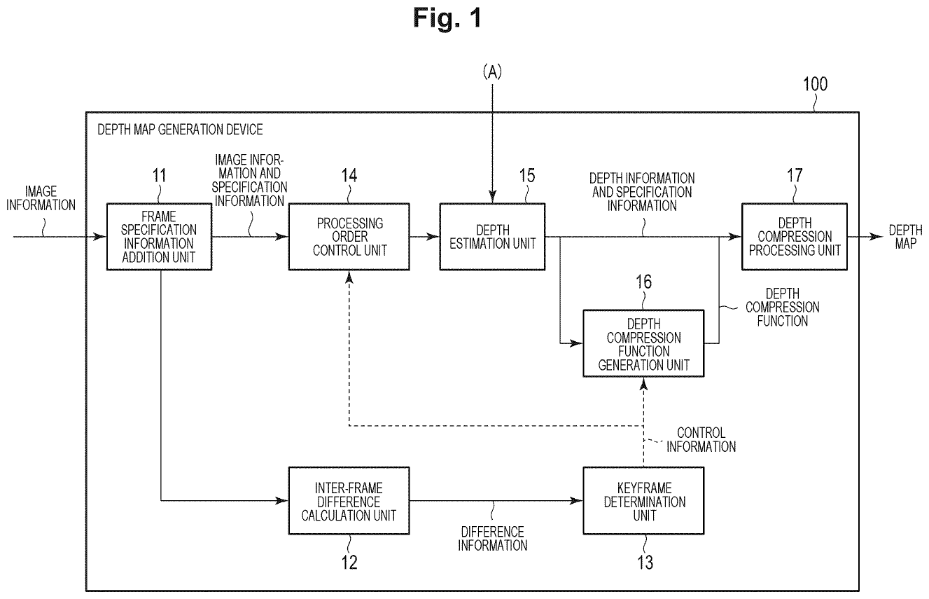

FIG. 1 is a block diagram illustrating an application example of a depth map generation device according to an embodiment of the present invention.

As illustrated in FIG. 1, a depth map generation device 100 serving as an image processing device according to the embodiment of the present invention includes a frame specification information addition unit 11, an inter-frame difference calculation unit 12, a keyframe determination unit 13, a processing order control unit 14, a depth estimation unit 15, a depth compression function generation unit 16, and a depth compression processing unit 17.

In the present embodiment, the depth map generation device 100 can appropriately set a frame used for generating a depth compression function (hereinafter, referred to as a keyframe).

Specifically, only in a case where a difference between a plurality of chronologically continuous frames in a moving image that is an input image, for example, a difference between a frame to be processed and a chronologically previous frame of the frame is relatively large, for example, the difference exceeds a predetermined threshold, the depth map generation device 100 sets a keyframe corresponding to the frame to be processed and also sets a depth compression function on the basis of the keyframe.

Meanwhile, in a case where the difference between the frame to be processed and the chronologically previous frame of the frame is relatively small, for example, the difference is equal to or less than the predetermined threshold, the keyframe is not set for the frame to be processed. In this case, a depth compression function generated based on a frame that is the past frame and has already been set as the latest keyframe, that is, a chronologically previous keyframe of the frame to be processed, can be used as a depth compression function corresponding to the frame to be processed.

Therefore, as to each frame having a relatively small chronological difference, it is possible to narrow down keyframes to be set as a generation source of a depth compression function. This makes it possible to prevent an influence caused by variation of the depth compression function.

Further, the frame to be processed having a relatively large inter-frame difference is set as a keyframe as described above, and thus, among all the frames, only some frames need to be set as keyframes. Therefore, a processing load for generating a depth compression function can be efficient.

In the present embodiment, the depth map generation device 100 can also calculate a size of a differential region between adjacent frames and an accumulated value thereof for each set of chronologically adjacent frames in the moving image that is an original image and set, as a keyframe, the frame to be processed at the time when the accumulated value satisfies a predetermined condition, for example, at the time when the accumulated value exceeds the threshold.

In the present embodiment, as described above, the depth compression processing can be effectively performed on the moving image.

The depth map generation device 100 is not limited to the setting of a keyframe based on a difference between frames and, for example, may set a frame corresponding to an i (i=1, 2, . . . ) frame subjected to an encoding process of a video as a keyframe in combination with the encoding process.

In order to avoid an influence caused by a significant change in the depth compression function due to switching of keyframes, that is, due to setting of a new keyframe at a timing subsequent to a keyframe set at a chronologically previous timing, in the present embodiment, the depth map generation device 100 can generate a depth compression function generated based on the switched keyframe, that is, the new keyframe for a predetermined number of chronologically continuous frames starting from the new keyframe before the keyframe is switched.

Further, the depth map generation device 100 can generate depth compression functions such that smoothing is performed between a previous depth compression function generated at a timing immediately before the new keyframe and a depth compression function generated based on the new keyframe, that is, such that the depth compression function corresponding to the previous keyframe is gradually changed to the depth compression function corresponding to the subsequent keyframe.

The depth map generation device 100 can also apply those generation results as depth compression functions corresponding to a predetermined number of frames traced back from the new keyframe.

Examples of switching of keyframes are described in (1) to (3) below.
(1) In a video effect such as a scene change, the inter-frame difference exceeds the threshold in a frame in which the scene change has been made. Therefore, the depth map generation device 100 sets a new keyframe when the inter-frame difference exceeds the threshold.
(2) In a scene in which only a subject is moving, individual inter-frame differences are small, and thus a new keyframe is set when the differences are chronologically accumulated and the accumulated value exceeds the threshold.
(3) A new keyframe is not set in each frame corresponding to a scene in which the subject is not substantially moving or is not moving at all after a frame that has been already set as a keyframe. That is, for each frame corresponding to the scene, the same keyframe can be continuously used in chronological order, and a depth compression function based on the keyframe can be generated.

Alternatively, for each of the above frames corresponding to the scene in which the subject is not substantially moving or is not moving at all, a depth compression function based on the previous keyframe traced back in chronological order from the above frames is extracted to be used for subsequent processing as a depth compression function corresponding to each of the above frames, and those extracted depth compression functions are used for depth compression processing performed by the depth compression processing unit 17 described later, the depth compression processing being for mapping depth information corresponding to each frame corresponding to the scene in which the subject is not substantially moving or is not moving at all onto each frame.

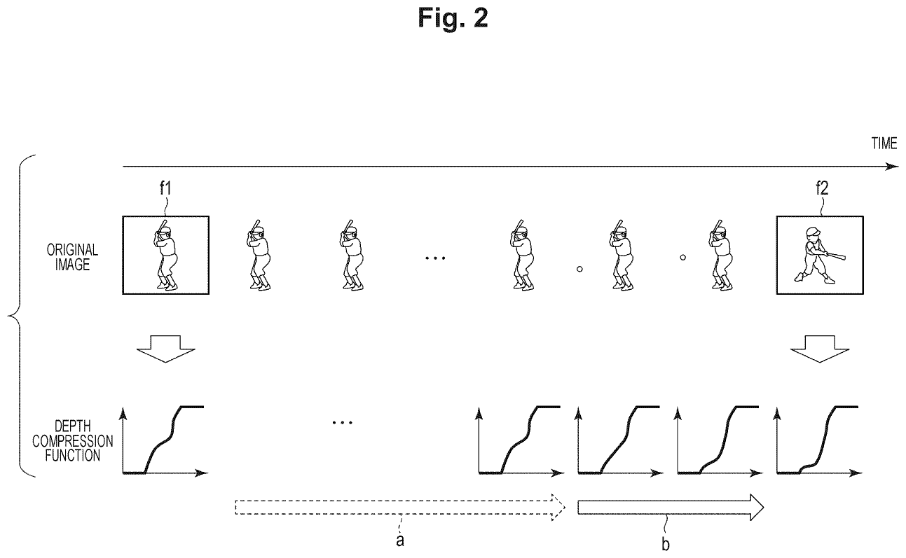

FIG. 2 illustrates an example of a relationship among chronologically continuous frames, keyframes, and depth compression functions.

In the example of FIG. 2, among frames regarding a motion of a sports player, a first frame f1 is set as a first keyframe, and a depth compression function regarding the keyframe is generated.

Then, at the timing when an accumulated value of inter-frame differences in a plurality of chronologically continuous frames starting from the keyframe exceeds the threshold, a frame f2 is set as a second keyframe, that is, as a new keyframe, and a depth compression function regarding the keyframe is generated.

In the present embodiment, the depth map generation device 100 can set depth compression functions regarding frames within ranges a and b between the first keyframe and the second keyframe, that is, frames that are not set as a keyframe between the first keyframe and the second keyframe, to the same depth compression function as the depth compression function set for the first keyframe.

Further, in the present embodiment, the depth map generation device 100 can set depth compression functions of several frames within the range b among the frames within the ranges a and b between the first keyframe and the second keyframe to depth compression functions that are gradually changed from the depth compression function for the first keyframe to the depth compression function for the second keyframe, that is, so-called smoothed depth compression functions. The frames within the range b are some frames after the first keyframe and before the second keyframe and are several continuous frames traced back in chronological order from the second keyframe.

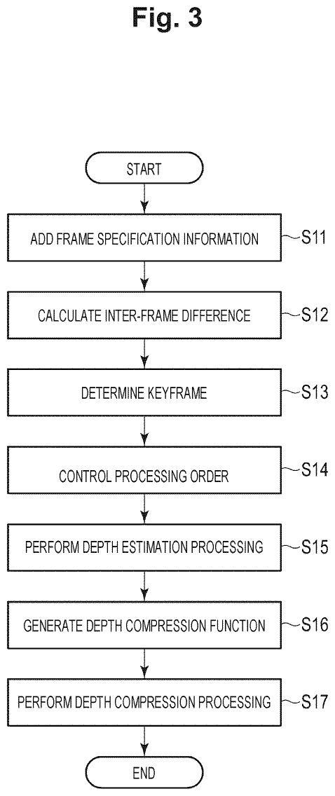

FIG. 3 is a flowchart showing an example of a processing operation by the image processing device according to the embodiment of the present invention.

The frame specification information addition unit 11 inputs image information that is a moving image from the outside, for example, a single perspective image or a stereo image, and adds specification information of each frame (also simply referred to as specification information or frame specification information) for storing the order of the frames of the image information to the image information (S11). The specification information includes, for example, identification numbers #1, #2, . . . , time stamps, and the like of the respective frames starting from the first frame.

The inter-frame difference calculation unit 12 calculates an inter-frame difference that is difference information between a frame to be processed (also referred to as a subsequent frame) and a chronologically previous frame (also referred to as a previous frame) that is a chronologically continuous to the above frame in the image information from the frame specification information addition unit 11 (S12).

The keyframe determination unit 13 sequentially sets the frame to be processed that is a possible keyframe from the chronologically continuous frames and calculates, for each frame to be processed, an accumulated value of inter-frame differences starting from the set latest keyframe to the current frame to be processed. Then, in a case where the accumulated value exceeds the threshold, the keyframe determination unit 13 determines the current frame to be processed as a new keyframe at the time when the accumulated value exceeds the threshold (S13).

The keyframe determination unit 13 notifies the processing order control unit 14 and the depth compression function generation unit 16 of control information for subsequent processing. The control information includes at least the specification information of the keyframes and may include, for example, information indicating a range of timings of a smoothing process, that is, timings for specifying frames for which depth compression functions are to be set by the smoothing process.

The processing order control unit 14 controls the processing order of the frames to be processed by the depth estimation unit 15 on the basis of the control information issued from the keyframe determination unit 13 and outputs each controlled frame to the depth estimation unit 15 (S14).

In the control of the processing order, the processing order by the depth estimation unit 15 and the depth compression function generation unit 16 in subsequent stages is controlled such that a depth of the previous frame and a depth of the subsequent frame determined as the keyframes by the keyframe determination unit 13 are estimated by the depth estimation unit 15 in preference to a depth of each frame after the previous frame and before the subsequent frame in chronological order and also such that a depth compression function used for mapping the depth of the previous frame and a depth compression function used for mapping the depth of the subsequent frame are generated by the depth compression function generation unit 16 in preference to a depth compression function used for mapping the depth of each frame after the previous frame and before the subsequent frame in chronological order.

The depth estimation unit 15 estimates depth information of each frame whose processing order is controlled by the processing order control unit 14, associates the estimated depth information with each frame and the specification information of the frame, and outputs the associated depth information to the depth compression function generation unit 16 and the depth compression processing unit 17 (S15).

Note that, instead of the estimation processing by the depth estimation unit 15, a depth camera image associated with a time stamp in the processing order may be set as the depth information (see (A) in FIG. 1).

The depth compression function generation unit 16 selects the depth information of the keyframes associated with the specification information of the keyframes issued from the keyframe determination unit 13 from the depth information of the frames output from the depth estimation unit 15, generates depth compression functions regarding the depth information on the basis of the selected depth information, sets a depth compression function regarding each frame between the keyframes by using the depth compression function regarding the previous frame, and outputs the depth compression functions to the depth compression processing unit 17 together with the specification information of the frames (S16).

Therefore, in the present embodiment, the depth compression functions regarding the keyframes and the frames between the keyframes among the frames are output.

In a case where the control information includes the range of the timings of the smoothing process as described above, the depth compression function generation unit 16 specifies the designated number of continuous frames traced back in chronological order from the set latest keyframe on the basis of the range of the timings.

Then, for the specified frames, the depth compression function generation unit 16 generates depth compression functions such that smoothing is performed between the depth compression functions regarding the unswitched and switched keyframes, that is, between the depth compression function regarding the latest keyframe corresponding to the subsequent frame and the depth compression function regarding the keyframe that has been set immediately before the latest keyframe, that is, the keyframe corresponding to the previous frame.

Based on the depth information and the specification information from the depth estimation unit 15 and the depth compression functions from the depth compression function generation unit 16, the depth compression processing unit 17 performs depth compression processing of mapping the depth information corresponding to each frame onto the frame (S17).

At this time, the depth compression processing unit 17 outputs a depth map regarding each frame arranged in the order based on the frame specification information.

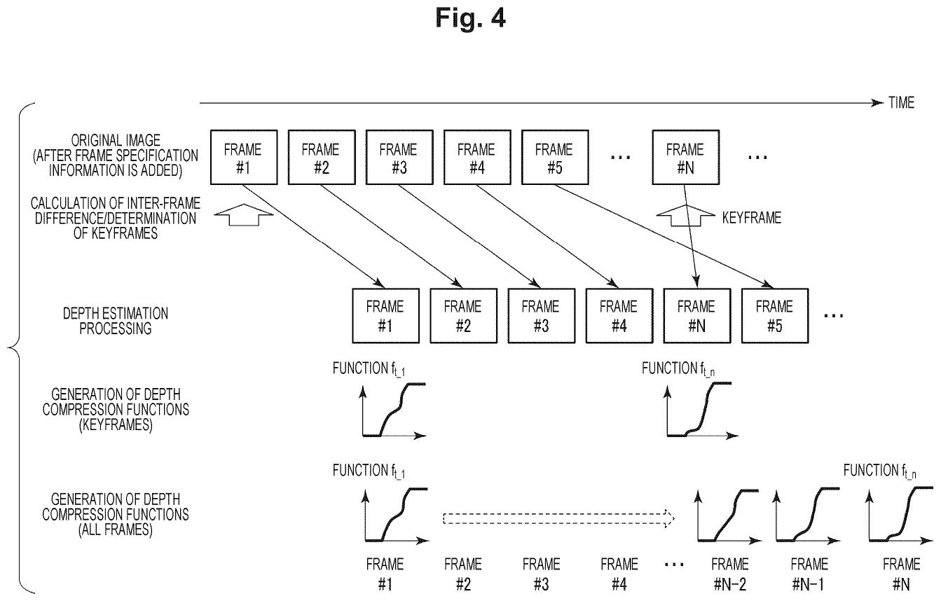

FIG. 4 illustrates a specific example of a processing operation by the depth map generation device according to the embodiment of the present invention.

FIG. 4 illustrates an example where pieces of frame specification information #1, #2, #3, #4, #5, and #6 (not illustrated), . . . , #N−1, #N, #N+1 (not illustrated), . . . corresponding to the chronological order are added to a plurality of chronologically continuous frames of an original image, and a first frame and an Nth frame are set as keyframes.

Hereinafter, the frames to which the pieces of the frame specification information #1, #2, #3, #4, #5, . . . , #N−1, #N, #N+1, . . . have been added will also be referred to as frames #1, #2, #3, #4, #5, . . . , #N−1, #N, #N+1 . . . .

In the present embodiment, the processing by the inter-frame difference calculation unit 12 and the keyframe determination unit 13 and the processing by the depth estimation unit 15 may be performed in separate threads.

In order to improve efficiency of the processing, in the example of FIG. 4, the processing order control unit 14 controls the processing order such that the depth information generation processing by the depth estimation unit 15 and the depth compression function generation processing by the depth compression function generation unit 16 for the frames #1 and #N serving as the keyframes among the frames from the keyframe #1 to the keyframe #N are performed in preference to the depth information generation processing and the depth compression function generation processing for the frames that are not keyframes, that is, the frames #1 to #N−1.

As a result, in the example of FIG. 4, the depth information generation processing and the depth compression function generation processing for the frames #1 and #N serving as the keyframes are preferentially performed, and the depth information generation processing is performed in the order of the frames #1, #2, #3, #4, #N, #5, #6, . . . , and #N−1. Then, in the example of FIG. 4, a depth compression function f_{t_1} for the frame #1 and a depth compression function f_{t_n} for the frame #N are generated.

Then, in setting of depth compression functions for all the frames, the depth compression function f_{t_1} for the frame #1 is used for each of the frames #1 to #N−2, and depth compression functions that are gradually changed, i.e., are smoothed between the generated depth compression functions f_{t_1} and f_{t_n} are set for the two frames #N−1 and #N−2 traced back from the frame #N.

Finally, when the depth compression processing is performed by the depth compression processing unit 17, the frames are rearranged in the order of the frame specification information added to the frames by the frame specification information addition unit 11, that is, in the order of the frames #1, #2, #3, #4, #5, . . . , #N−1, #N, #N+1 . . . as in FIG. 4, and the depth compression processing is performed on each rearranged frame.

In a case where, in the above setting of the smoothed depth compression functions, the frame number of the keyframe switched from the keyframe #1 for the depth compression function f_{t_1} is denoted by N, the depth compression function for a previous frame of the frame #N is denoted by f_{t_i}, the depth compression function for the frame #N is denoted by f_{t_n}, the depth compression function for a frame immediately after the frame #N is denoted by f_{t_j}, and a range of the frames to be smoothed is denoted by k, a depth compression function f_{t_m} corresponding to each frame having a frame number (N-m) will be described.

In a case of “0<m≤k”, that is, before the keyframe is switched as seen from the frame #1, the depth compression function fₜm of each frame is shown by Expression (1) below.

f_{t_m}=(m*f_{t_1}+(k+1−m)*f_{t_n})/(k+1) Expression (1)

In a case of “−k≤m<0”, that is, after the keyframe is switched as seen from the frame #1, the depth compression function f_{t_m} of each frame is shown by Expression (2) below.

f_{t_m}=((k+1+m)*f_{t_j}+(−1*m)*f_{t_n})/(k+1) Expression (2)

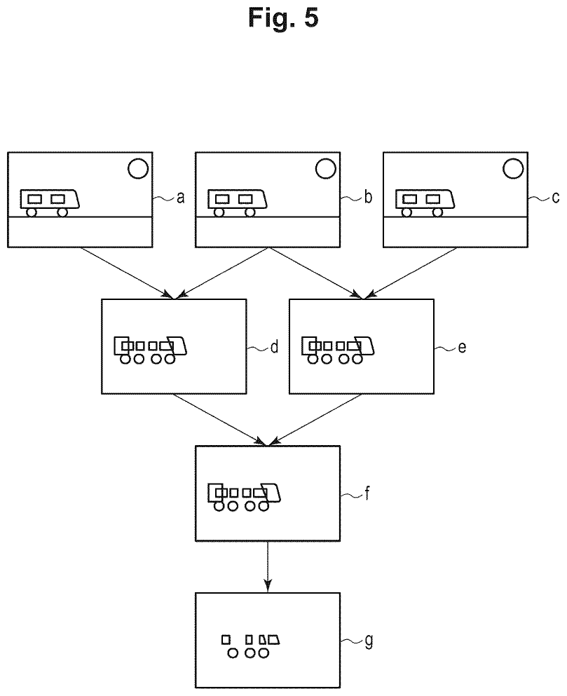

Next, an example of calculation of the inter-frame difference will be described. FIG. 5 illustrates an example of calculation of a difference between frames.

In the example of FIG. 5, the inter-frame difference calculation unit 12 compares pixels of two chronologically continuous frames, for example, a frame A corresponding to a in FIG. 5 and a frame B corresponding to b in FIG. 5, and considers a pixel having a difference in pixel value as a pixel in which a difference has been generated. The same applies to the frame B corresponding to b in FIG. 5 and a frame C corresponding to c in FIG. 5.

The inter-frame difference calculation unit 12 calculates an absolute value of each difference between the continuous frames and calculates images corresponding to the absolute values as “difference images” corresponding to d and e in FIG. 5. The reference sign d shows an image corresponding to the absolute value of the difference between the frame A and the frame B, and the reference sign e shows an image corresponding to the absolute value of the difference between the frame B and the frame C.

The inter-frame difference calculation unit 12 calculates an AND image of the “difference images” corresponding to d and e, that is, an image shown by f in FIG. 5.

The inter-frame difference calculation unit 12 performs binarization processing of the AND image and outputs the processing result as the image corresponding to f in FIG. 5. In other words, the inter-frame difference calculation unit 12 can calculate a region having two chronologically continuous frame differences.

Further, as post-processing, the inter-frame difference calculation unit 12 may perform processing of excluding noise from the calculated differences.

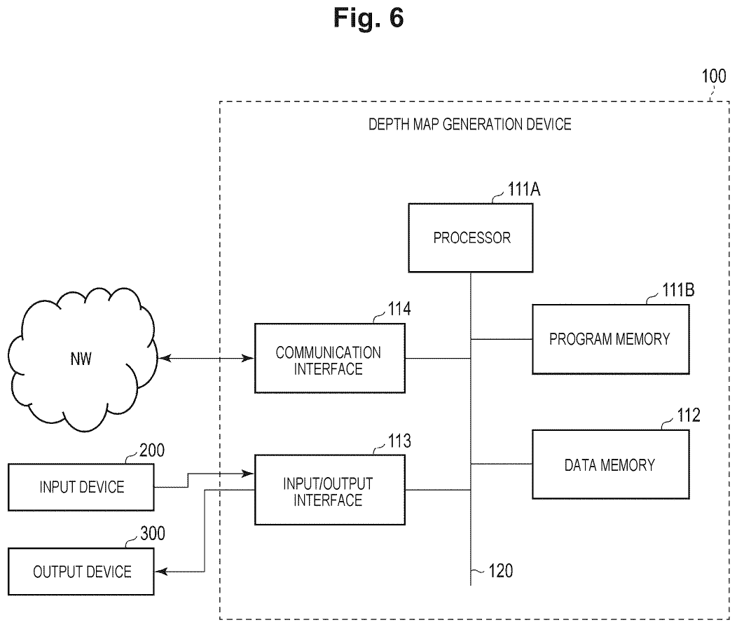

FIG. 6 is a block diagram illustrating an example of a hardware configuration of the depth map generation device according to the embodiment of the present invention.

In the example of FIG. 6, the depth map generation device 100 according to the above embodiment is configured as, for example, a server computer or a personal computer and includes a hardware processor 111A such as a central processing unit (CPU). The hardware processor 111A is connected to a program memory 111B, a data memory 112, an input/output interface 113, and a communication interface 114 via a bus 120.

The communication interface 114 includes, for example, one or more wireless communication interface units and enables transmission/reception of information to/from a communication network NW. The wireless interface is, for example, an interface employing a low-power wireless data communication standard such as a wireless local area network (LAN).

The input/output interface 113 is connected to an input device 200 and an output device 300 attached to the depth map generation device 100 and used by a user, for example.

The input/output interface 113 performs processing of fetching operation data input by, for example, the user through the input device 200 such as a keyboard, a touch panel, a touchpad, or a mouse, outputting output data to the output device 300 including a display device made from, for example, liquid crystal or organic electro-luminescence (EL), and displaying the output data on the output device. Note that the input device 200 and the output device 300 may be devices included in the depth map generation device 100 or may be an input device and output device of another information terminal that can communicate with the depth map generation device 100 via the network NW.

The program memory 111B is used as a non-transitory tangible storage medium, for example, as a combination of a non-volatile memory enabling writing and reading at any time, such as a hard disk drive (HDD) or a solid state drive (SSD), and a non-volatile memory such as a read only memory (ROM) and stores programs necessary for executing various kinds of control processing according to the embodiment.

The data memory 112 is used as a tangible storage medium, for example, as a combination of the above non-volatile memory and a volatile memory such as a random access memory (RAM) and is used to store various kinds of data acquired and created during various kinds of processing.

The depth map generation device 100 according to the embodiment of the present invention can be configured as a data processing device including the frame specification information addition unit 11, the inter-frame difference calculation unit 12, the keyframe determination unit 13, the processing order control unit 14, the depth estimation unit 15, the depth compression function generation unit 16, and the depth compression processing unit 17 illustrated in FIG. 1 as processing function units by software.

Each information storage unit used as a work memory or the like by each unit of the depth map generation device 100 can be configured by using the data memory 112 in FIG. 6. However, those configured storage areas are not essential configurations in the depth map generation device 100 and may be areas provided in, for example, an external storage medium such as a universal serial bus (USB) memory or a storage device such as a database server provided in a cloud.

All the processing function units in the frame specification information addition unit 11, the inter-frame difference calculation unit 12, the keyframe determination unit 13, the processing order control unit 14, the depth estimation unit 15, the depth compression function generation unit 16, and the depth compression processing unit 17 can be achieved by causing the hardware processor 111A to read and execute the programs stored in the program memory 111B. Note that some or all of these processing function units may be implemented in other various forms including an integrated circuit such as an application specific integrated circuit (ASIC) or a field-programmable gate array (FPGA).

In a case where a size of a differential region between a previous frame and a subsequent frame in chronological order in a moving image satisfies a predetermined condition and is large, the depth map generation device according to the embodiment of the present invention can determine the previous frame and the subsequent frame as keyframes, estimates a depth of each frame from the previous frame to the subsequent frame, generates depth compression functions corresponding to the previous frame and subsequent frame serving as the keyframes, and use the depth compression function generated corresponding to the previous frame for each frame that is not a keyframe between the previous frame and the subsequent frame.

That is, for depth compression processing of a depth map necessary for effective 3D representation, the depth map generation device according to the embodiment of the present invention updates the depth compression function, that is, generates a new depth compression function at the timing when an inter-frame difference having a magnitude satisfying the predetermined condition is generated, focusing on the fact that there is a relation between a chronological inter-frame difference and a depth map of an original video. This makes it possible to optimize the depth compression processing in videos of various variations, which has not been achieved by related arts.

Further, when the depth compression function is updated, the depth map generation device can set a smoothed depth compression function for each frame in a certain period of time traced back from a new keyframe. This makes it possible to prevent a rapid change in the depth compression function in the keyframe in which the depth compression function is updated and to achieve 3D viewing with less discomfort.

The method described in each embodiment can be stored in a recording medium such as a magnetic disk (e.g. Floppy (registered trademark) disk or hard disk), an optical disc (e.g. CD-ROM, DVD, or MO), or a semiconductor memory (e.g. ROM, RAM, or flash memory) as a program (software means) that can be executed by a computer and can be distributed by being transmitted through a communication medium. Note that the programs stored in the medium also include a setting program for configuring, in the computer, software means (including not only an execution program but also tables and data structures) to be executed by the computer. The computer that implements the present device executes the above processing by reading the programs recorded in the recording medium, constructing the software means by the setting program as needed, and controlling an operation by the software means. Note that the recording medium described in the present specification is not limited to a recording medium for distribution, but includes a storage medium such as a magnetic disk or a semiconductor memory provided in the computer or in a device connected via a network.

The present invention is not limited to the above embodiment, and various modifications can be made in the implementation stage within the scope of the invention. Each embodiment may be implemented in appropriate combination, and in that case, combined effects can be obtained. Further, the above embodiment includes various inventions, and the various inventions can be extracted based on a combination selected from a plurality of disclosed components. For example, even if some components are deleted from all the components described in the embodiment, in a case where the problem can be solved and the effects can be obtained, a configuration from which the components have been deleted can be extracted as an invention.

### REFERENCE SIGNS LIST

100 Depth map generation device
11 Frame specification information addition unit
12 Inter-frame difference calculation unit
13 Keyframe determination unit
14 Processing order control unit
15 Depth estimation unit
16 Depth compression function generation unit
17 Depth compression processing unit

1. An image processing device, comprising:
difference calculation circuitry configured to calculate a size of a differential region between one frame and a frame at a timing later than a timing of the one frame in chronological order in a moving image;
frame determination circuitry configured to, when the size of the differential region calculated by the difference calculation circuitry satisfies a predetermined condition and is large, determine the one frame as a first frame serving as a generation source of a function used for mapping a depth of the frame and determine the frame at the later timing as a second frame serving as a generation source of a function used for mapping a depth of the frame;
depth estimation circuity configured to estimate a depth of each frame from the first frame to the second frame; and
function generation circuitry configured to generate the function used for mapping the depth of the first frame determined as the generation source frame by the frame determination circuitry as a function usable for mapping the depth of the each frame between the first frame and the second frame and generate the function used for mapping the depth of the second frame determined as the generation source frame by the frame determination circuitry.

2. The image processing device according to claim 1, wherein:
the difference calculation circuitry
calculates a size of a differential region between chronologically adjacent frames between the one frame and the later frame for each set of the adjacent frames; and
the frame determination circuitry
determines the one frame as the first frame and the frame at the later timing as the second frame when an accumulated value of the calculated sizes starting from the one frame satisfies the predetermined condition and is large.

3. The image processing device according to claim 1, wherein:
the function generation circuitry
further generates functions gradually switch from the generated function used for mapping the depth of the first frame to the generated function used for mapping the depth of the second frame as a function used for mapping a depth of each of a plurality of continuous frames traced back in chronological order from the second frame.

4. The image processing device according to claim 1, further comprising:
processing order control circuitry configured to control a processing order by the depth estimation circuitry such that the depth of the first frame determined as the generation source frame by the frame determination circuitry and the depth of the second frame determined as the generation source frame by the frame determination circuitry are estimated by the depth estimation circuitry in preference to the depth of each frame after the first frame and before the second frame in chronological order.

5. The image processing device according to claim 1, further comprising:
processing order control circuitry configured to control a processing order by the function generation circuitry such that the function used for mapping the depth of the first frame determined as the generation source frame by the frame determination circuitry and the function used for mapping the depth of the second frame determined as the generation source frame by the frame determination circuitry are generated by the function generation circuitry in preference to the function used for mapping the depth of each frame after the first frame and before the second frame in chronological order.

6. An image processing method, comprising:
calculating a size of a differential region between one frame and a frame at a timing later than a timing of the one frame in chronological order in a moving image;
when the calculated size of the differential region satisfies a predetermined condition and is large, determining the one frame as a first frame serving as a generation source of a function used for mapping a depth of the frame and determining the frame at the later timing as a second frame serving as a generation source of a function used for mapping a depth of the frame;
estimating a depth of each frame from the first frame to the second frame; and
generating the function used for mapping the depth of the first frame as a function usable for mapping the depth of the each frame between the first frame and the second frame and generating the function used for mapping the depth of the second frame.

7. The image processing method according to claim 6, wherein:
the calculating of the difference includes
calculating a size of a differential region between chronologically adjacent frames between the one frame and the later frame for each set of the adjacent frames; and
the determining of the first and second frames includes
determining the one frame as the first frame and the frame at the later timing as the second frame when an accumulated value of the calculated sizes starting from the one frame satisfies the predetermined condition and is large.

8. A non-transitory computer readable medium storing an image processing program for causing a processor to function as each of the circuitries of the image processing device according to claim 1.

9. A non-transitory computer readable medium storing an image processing program for causing a processor to perform the method of claim 6.
